(19) United States
(12) Patent Application Publication
(10) Pub. No.: US 2023/0396491 A1
(43) Pub. Date: Dec. 7, 2023

(54) CONTROLLING NETWORK SETUP OF ELECTRONIC DEVICE

(71) Applicant: Hewlett-Packard Development Company, L.P., Spring, TX (US)

(72) Inventors: Jongheon Ji, Seongnam-si (KR); Sangho LEE, Seongnam-si (KR); Dosoon LEE, Seongnam-si (KR); Hyeokmin GWON, Seongnam-si (KR)

(21) Appl. No.: 18/032,618

(22) PCT Filed: Jan. 26, 2021
(86) PCT No.: PCT/US2021/014996

§ 371 Date: Apr. 19, 2023

(30) Foreign Application Priority Data
Oct. 21, 2020 (KR) 10-2020-0136753

(51) Int. Cl. H04L 41/0803; H04W 76/10

(52) U.S. Cl. CPC H04L 41/0803; H04W 76/10

(57) ABSTRACT

As example wireless network setup method of an electronic device includes, executing an application for use of an image forming apparatus, wherein the image forming apparatus is connected to a network different from one to which the electronic device is connected, displaying information related to one or more image forming apparatuses stored in the application, receiving a selection of information related to the image forming apparatus through the application, obtaining the information related to the image forming apparatus, and changing a wireless network setting of the electronic device for connection of the electronic device with the image forming apparatus based on wireless network setup information that corresponds to the obtained information related to the image forming device.

### BACKGROUND

There exist different types of image forming apparatuses, inciuding printers, scanners, photocopiers, facsimile machines, etc., as well as multi-function products (MFF's) that may provide a combination of functions, e.g., print, copy, scan, and fax functions.

An Image forming apparatus may be connected to an electronic device of a user via a wired or wireless network and operated. An application for connection with an image forming apparatus and control of the image forming apparatus may be installed in the electronic device of the user. Through the application, basic functions such as copying, printing, scanning, and the like of the image forming apparatus, and various additional functions may be used.

Currently, in order to have an image forming apparatus operated in a condition in which an electronic device is connected thereto through an application of the electronic device in a wireless communication environment, the image forming apparatus and the electronic device should be connected to the same wireless network.

### BRIEF DESCRIPTION OF THE DRAWINGS

FIG. 1 is a schematic diagram illustrating a system comprising an electronic device and image forming apparatuses according to an example;

FIG. 2 is a block diagram illustrating an electronic device according to an example;

FIG. 3 is a diagram showing a user interface provided on a display of an electronic device according to an example;

FIG. 4 is a diagram showing a user interface provided on a display of an electronic device according to an example;

FIG. 5 is a flowchart describing a network setup method of an electronic device according to an example;

FIG. 6 is a schematic diagram of a system comprising electronic devices and a user device according to an example; and

FIG. 7 illustrates a computer program stored on a computer- readable recording medium according to an example.

### DETAILED DESCRIPTION

In order for a user to use an image forming apparatus through an electronic device, for example, through an application installed in the electronic device, the electronic device of the user and the image forming apparatus should be connected to the same wireless network. Therefore, in case that the user intends to connect the electronic device to the image forming apparatus and use the image forming apparatus, when the electronic device and the image forming apparatus are not connected to the same wireless network, the user determines which wireless network the image forming apparatus is connected to and, according to a result of the determination, may manually change a network setting of the electronic device so that the electronic device is connected to the same wireless network to which the image forming device is connected.

Accordingly, examples are directed to a technique in which a network setting of an electronic device of a user may be automatically changed so as to be the same as that of a wireless network to which an image forming apparatus is connected, without user intervention.

To this end, an electronic device according to an example is provided. When a user connects an image forming apparatus to the electronic device through a wireless network and uses the connected image forming apparatus, the electronic device stores setup information on the corresponding wireless network in the electronic device. Thereafter, when the user intends to use the image forming apparatus, the electronic device automatically changes a wireless network setting of the electronic device using the wireless network setup information that is stored. Therefore, even when the electronic device and the image forming apparatus are not connected to the same network, the electronic device may be connected to the image forming apparatus by automatically changing a network setting to that of the wireless network to which the image forming apparatus is connected without user intervention, thereby improving user experience.

Various terms used in the following examples are chosen from a terminology of commonly used terms in consideration of their function herein, which may be appreciated differently depending on an intention of a person skilled in the art, a precedent case, or an emerging new technology. In some cases, terms may be construed as set forth in the following examples. Accordingly, the terms used herein are to be defined consistently with their meanings in the context of the various examples, rather than simply by their plain and ordinary meaning.

The terms “comprising,” “including,” “having,” “containing,” etc. are used herein when specifying the presence of the elements listed thereafter. Unless otherwise indicated, these terms and variations thereof are not meant to exclude the presence or addition of other elements.

As used herein, the ordinal terms “first,” “second,” and so forth are meant to identify several similar elements. Unless otherwise specified, such terms are not intended to impose limitations, e.g., a particular order of these elements or of their use, but rather are used merely for referring to multiple elements separately. For instance, an element may be referred to in an example with the term “first” while the same element may be referred to in another example with a different ordinal number such as “second” or “third.” In such examples, the ordinal terms are not to limit the scope of the present disclosure. Also, the use of the term “and/or” in a list of multiple elements is inclusive of all possible combinations of the listed items, including any one or plurality of the items.

The term “image forming job” as used herein may encompass any of a variety of image-related jobs, such as a print job, a scan job, a photocopy job, a facsimile transmission job, and the like, that involve an operation of forming an image and/or other processing operation, e.g., creation, generation and/or transfer of an image file. Furthermore, an image forming job performed by an image forming apparatus may comprise various jobs related to printing, photocopying, scanning, faxing, storing, transmitting, coating, etc.

The term “image forming apparatus” as used herein may encompass any of a variety of apparatuses, such as a printer, a scanner, a photocopier, a facsimile machine, a multi-function product (MFPs), and so on, that carries out an image forming job. Moreover, an image forming apparatus may be a two-dimensional (2D) or a three-dimensional (3D) image forming apparatus.

The term “user” as used herein may refer to a person who manipulates an image forming apparatus to operate an image forming job. Further, the term “administrator” as used herein may refer to a person who has access to the entire functionality of an image forming apparatus. In some examples, one person may have both the roles of an administrator and a user.

The term “electronic device,” “electronic apparatus,” or “user device” as used herein may refer to an information processing device that can be used by a user, such as a computer, a lap top, a tablet personal computer (PC), a mobile phone, etc.

Certain examples of the present disclosure will now be described with reference to the accompanying drawings, The various examples may, however, be implemented in many different forms and should not be construed as limited to the examples set forth herein. Rather, these examples are given in order to provide a better understanding of the scope of the present disclosure.

Hereinafter, examples of the above-described image forming apparatus will be described with reference to the accompanying drawings.

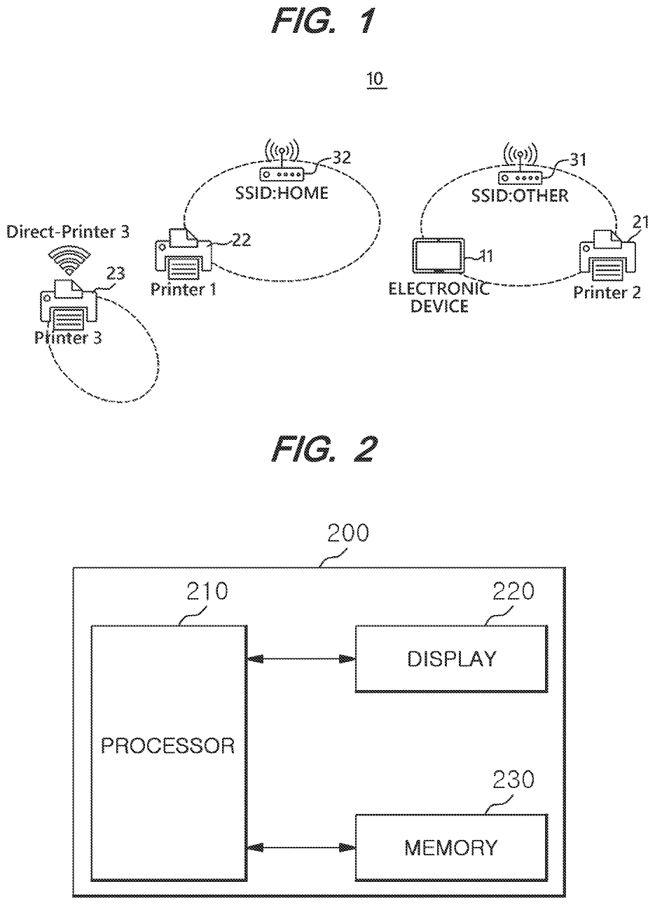

FIG. 1 is a schematic diagram illustrating a system comprising an electronic device and image forming apparatuses according to an example.

Referring to FIG, 1, a system 10 may comprise an electronic device 11 that can be used by a user, image forming apparatuses 21, 22, and 23 connectable to the electronic device 11, and routers 31 and 32 that provide a wireless network connection between the electronic device 11 and the image forming apparatuses 21, 22, and 23. However, the system 10 illustrated in FIG. 1 is merely an example and is not intended to be limiting. Therefore, the electronic device 11 and the image forming apparatuses 21, 22, and 23 should not be limited to the form of those of the system 10 depicted in FIG, 1.

The electronic device 11 may be an information processing device that can be used by the user, and may be connected to one or more of the image forming apparatuses 21, 22, and 23 to respectively control the image forming apparatuses 21, 22, and 23 to perform an operation including an image forming job. A separate application for controlling the image forming apparatuses 21, 22, and 23 to perform the operation including the image forming job may be installed in the electronic device 11. The electronic device 11 and the image forming apparatuses 21, 22, and 23 may be connected to each other through a wireless network. For example, the electronic device 11 may be connected to each of the image forming apparatuses 21 and 22 respectively by the router 31 and the router 32 that provide a wireless network connection. Further, for example, the electronic device 11 and the image forming apparatus 23 may be connected by using a communication technique for connecting one device to another device in a one-to-one correspondence, such as Wi-Fi Direct. When the electronic device 11 is connected to each of the image forming apparatuses 21, 22, and 23 through the same respective wireless networks, desired jobs may be performed by way of controlling functions of the image forming apparatuses 21, 22, and 23 by the electronic device 11, for example, through the application installed in the electronic device 11.

Each of the image forming apparatuses 21, 22, and 23 may refer to an individual device such as a printer, a scanner, a photocopier, a fax machine, and the like. Further, each of the image forming apparatuses 21, 22, and 23 may refer to a multi-function product (MFF) in which functions of the individual devices are integrated into one device. The system 10 may be provided with a plurality of image forming apparatuses, as illustrated in FIG. 1, and alternatively, may be provided with one image forming apparatus.

The image forming apparatuses 21, 22, and 23 may provide various additional functions as well as basic functions, such as copying, printing, scanning, and the like, The functions provided by the image forming apparatuses 21, 22, and 23 may be provided solely by the image forming apparatuses 21, 22, and 23 themselves, or may be provided by way of controlling the image forming apparatuses 21, 22, and 23 through the electronic device 11,

The routers 31 and 32 are devices that enable other devices, such as the electronic device 11 and the image forming apparatuses 21, 22, and 23, to be connected to a network. The electronic device 11 and the image forming apparatuses 21, 22, and 23 may be connected to a wireless network, and provide a user with functions of each device that can be implemented by utilizing the wireless network. Also, the electronic device 11 and the image forming apparatuses 21, 22, and 23 may be connected to each other through a same wireless network, such that the image forming apparatuses 21, 22, and 23 may be controlled by the electronic device 11.

Hereinafter, an example of an electronic device will be described.

FIG. 2 is a block diagram illustrating an electronic device according to an example.

Referring to FIG. 2, an electronic device 200 may include a processor 210, a display 220, and a memory 230. However, the electronic device 200 is not limited to that represented in FIG. 2. For example, the electronic device 200 may further comprise components not illustrated in FIG. 2, for example, a power supply for supplying power to each of the components, a communication unit for providing a communication function, or other components, and at least one of the components as depicted in FIG. 2 may be omitted in the electronic device 200.

The processor 210 may control and perform a function that may be provided by the electronic device 200, and may include a central processing unit (CPU), a graphic processing unit (GPU), and the like. The processor 210 may control and perform various types of operations required to perform functions provided by an application installed in the electronic device 200. For instance, the processor 210 may execute one or more instructions stored in the memory 230. Further, the processor 210 may retrieve information stored in the memory 230. In addition, the processor 210 may store new information in the memory 230 and update information already stored therein. For example, the processor 210 may perform an operation associated with instructing an image forming apparatus to perform a predetermined job through the application for controlling the image forming apparatus, and may perform an operation of obtaining information necessary for control of the image forming apparatus from the memory 230 or storing the information in the memory 230.

The display 220 may include a user interface (not illustrated) that serves as an output unit to output various types of information to the user of the electronic device 200 and as an input unit to receive an input from the user.

The input unit may receive various inputs from the user. For example, the user may select an image forming job to be carried out through the input unit, and select various options associated with the image forming job that may be used in the image forming apparatus. The input unit may include, for example, a touch pad, a touch screen, or the like. In an example, the input unit may be a separate device other than the display 220, For example, the input unit may be a device that may receive various types of inputs from the user, such as a keyboard, a keypad, a physical button, or the like.

The output unit may provide or output, for example, a progress status or a result of a job performed through the electronic device 200. In an example, the output unit may be a separate device other than the display 220. For example, the output unit may be a device that may output various types of outputs to the user, such as a speaker or the like.

The memory 230 may be implemented by various storage media for storing data, such as a random access memory (RAM), a read only memory (ROM), or the like, Various types of information may be stored in the memory 230. For example, one or more instructions executable by the processor 210 may be stored in the memory 230.

In addition, a predetermined application may be installed or stored in the memory 230. The application may be designed to provide various additional functions and may include the application for controlling the image forming apparatus as described above.

Hereinafter, example operations that may be performed by the electronic device 200 will be described.

The user may execute an application for performing an image forming job, such as printing, at an image forming apparatus through the electronic device 200, for example, through the application installed in the electronic device 200. When the application is executed, information related to image forming apparatuses that may be connected to and used by the electronic device 200 is displayed through the application. The information related to image forming apparatuses may include a list of available image forming apparatuses, an identifier or a device name assigned to each of the image forming apparatuses, and the like.

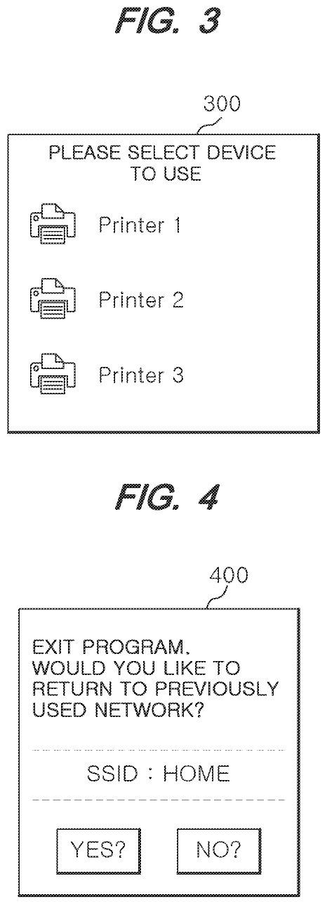

FIG. 3 is a diagram showing a user interface provided on a display of an electronic device according to an example.

Referring to FIG. 3, a list 300 of image forming apparatuses that may currently be connected to the electronic device 200 may be displayed to the user on the display 220. When the user selects an image forming apparatus to be used from the displayed list 300 of image forming apparatuses, for example, by touching a corresponding printer displayed on the display 220, the processor 210 of the electronic device 200 receives the selection of the user.

After the electronic device 200 receives the selection of information related to the image forming apparatus so selected, it is determined whether the corresponding image forming apparatus and the electronic device 200 are currently connected to a same wireless network and able to perform an image forming job or the like.

When the image forming apparatus and the electronic device 200 are not connected, the processor 210 of the electronic device 200 determines whether there is available network information that may be used by the electronic device 200 for connection with the selected image forming apparatus. For example, the processor 210 may determine whether such network information is stored in the memory 230. The pre-stored network information may include information that has been stored in association with identification information (e.g., an identifier of the image forming apparatus, an Internet Protocol (IP) address, etc.) of the image forming apparatus when the corresponding image forming apparatus and the electronic device 200 were previously connected, and may include wireless network setup information used in the previous connection between the electronic device 200 and the image forming apparatus. That is, the wireless network setup information (e.g., information for router connection, information for device-to-device connection, etc.) that was used when the electronic device 200 and the image forming apparatus were previously connected to each other through the same wireless network to perform the image forming job may be stored in the electronic device 200.

When the electronic device 200 determines that there is no pre-stored network setup information, the electronic device 200 may request the user to, for example, change a current wireless network connection setting of the electronic device 200 to be the same as that of a wireless network to which a desired image forming apparatus is currently connected. For example, the electronic device 200 may display a notification to the user for guiding the user to change the wireless network connection setting of the electronic device 200 in a setup menu of the electronic device 200. Alternatively, instead of requesting an explicit input from the user, the electronic device 200 may access a separate database that may provide corresponding information and obtain the wireless network setup information required for the current connection setup.

In contrast, when the electronic device 200 determines that there is pre-stored network setup information in association with the image forming apparatus to be used, the electronic device 200 may obtain the pre-stored wireless network setup information. Based on the wireless network setup information so obtained, the electronic device 200 may control a wireless network setup process for the electronic device 200. That is, the electronic device 200 may change its current wireless network connection setting according to the pre-stored wireless network setup information, and, thus, may access the same wireless network as the one to which the image forming apparatus is connected, and be connected to the image forming apparatus, As a result, once there is a history of successful connection between the image forming apparatus and the electronic device 200, the wireless network connection setup for connecting the image forming apparatus with the electronic device 200 may be automatically performed thereafter without user intervention, thereby enhancing user experience.

Prior to changing the wireless network setting of the electronic device 200 according to the obtained wireless network setup information, the electronic device 200 may also store the network setup information on the wireless network to which the electronic device 200 is currently connected. The current wireless network setup information may be stored, for example, in the memory 230 or other suitable storage. The current wireless network setup information stored in this way may be later used when the user, after completing the image forming job, desires to reconnect to the wireless network that was used prior to the image forming job, either automatically or on the basis of a command from the user.

Alternatively, or additionally, the electronic device 200 may determine whether an image forming apparatus and the electronic device 200 are currently connected to a same wireless network to perform the image forming job or the like. When it is determined that the image forming apparatus and the electronic device 200 are connected to the same wireless network, the electronic device 200 may associate the wireless network setup information used for the current connection with the identification information of that image forming apparatus, and store same in the memory 230 for later use. For example, when the wireless network setup information used for the current connection is information that was initially input by the user, e.g., information received in response to the notification for explicitly guiding the user to change the network setting of the electronic device 200, the electronic device 200 may store the corresponding wireless network setup information in the memory 230 for later use. In an example, even when there is pre-stored wireless network setup information associated with a connection between an image forming apparatus and the electronic device 200, the pre-stored wireless network setup information may be updated and stored if that image forming apparatus and the electronic device 200 are currently connected to each other using a network setting that is different from a previously used network setting.

When the electronic device 200 is connected to the same wireless network as the one to which the image forming apparatus is connected, the image forming apparatus may be controlled through the electronic device 200, for example, through the application installed in the electronic device 200. Accordingly, the user may perform a predetermined job on the image forming apparatus.

Alternatively, or additionally, after the desired job is finished by the image forming apparatus, the electronic device 200 may determine whether to return the electronic device 200 to the previous network connection that had been used before the image forming apparatus was used, for example by receiving a user input.

FIG. 4 is a diagram showing a user interface provided on a display of an electronic device according to an example.

Referring to FIG. 4, the processor 210 of the electronic device 200 may operate to display a user interface 400 on the display 220, through which the user may choose whether to change the network setting of the electronic device 200 according to the previous network setup information after having the job completed by the image forming apparatus. The user interface 400 may display an interface that receives from the user an input on whether to return the network setting of the electronic device 200 to the previous network setting that has been used prior to the connection with the image forming apparatus, together with a network identifier corresponding to the wireless network setup information to be restored.

When the electronic device 200 receives an input indicating that the user selects to restore the previous network setting, the electronic device 200 may change its wireless network setting using the wireless network connection information that has been stored prior to the connection with the image forming apparatus, as described above, and be reconnected to the wireless network to which it had been connected prior to the connection with the image forming apparatus.

In contrast, depending on a pre-designated setting, the electronic device 200 may automatically return to the previous network setting without inquiring upon the user, or may maintain the wireless network setting used for the current connection with the image forming apparatus, which may be chosen by the user through a setup menu of the application installed in the electronic device 200.

An example method of determining whether to end the use of the image forming apparatus may include, for example, determining whether the user has performed an operation for ending the application, receiving from the user an input on the application regarding whether to end the use of the image forming apparatus after the image forming job is completed, or the like. However, it may be clearly understood by those skilled in the art that the present application is not limited thereto.

According to an example, when the user first uses an image forming apparatus, the corresponding wireless network setup information is stored, and when the user desires to use that image forming apparatus thereafter, the electronic device may automatically change its wireless network setting using the corresponding wireless network setup information so stored. As a result, it is possible to automatically change the network setting of the electronic device of the user to be the same as that of the wireless network to which the image forming apparatus is connected, without user intervention.

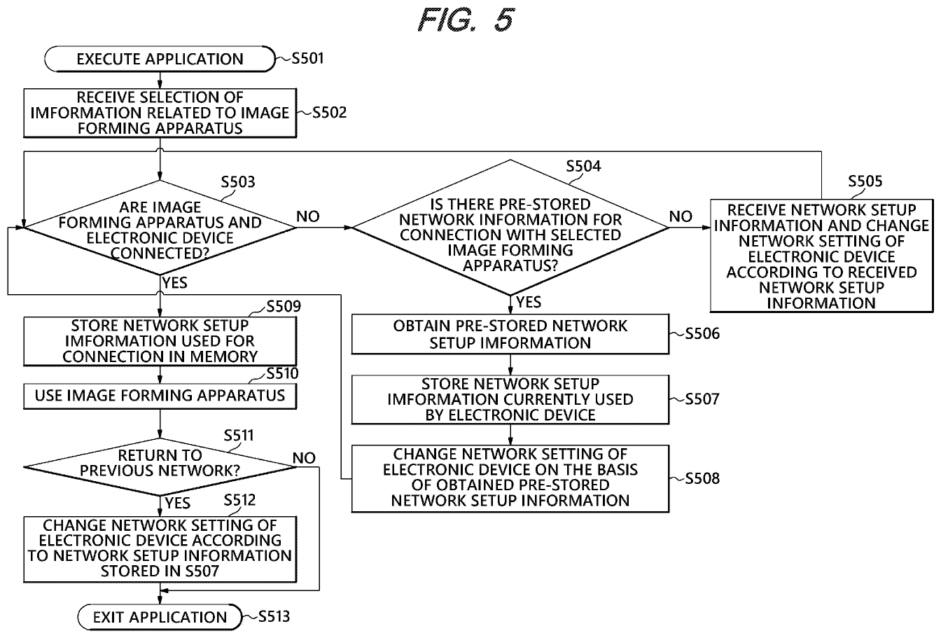

Hereinafter, an example network setup method of an electronic device will be described with reference to FIG. 5.

FIG, 5 is a flowchart describing a network setup method of an electronic device according to an example.

Referring to FIG. 5, an application of an electronic device 200 may be executed so as to use an image forming apparatus in operation 5501.

In an example, information related to image forming apparatuses that may be connected to and used by the electronic device 200 is displayed. The information related to the image forming apparatuses may include a list of image forming apparatuses available, an identifier or device name assigned to each of the image forming apparatuses, and the like. For example, a list 300 of image forming apparatuses that currently can be connected to the electronic device 200 may be displayed to the user. When the user selects an image forming apparatus to be used from the displayed list 300 of the image forming apparatuses through a user interface displayed on a display 220, for example, by touching a corresponding printer icon displayed on the display, a processor 210 of the electronic device 200 receives the selection from the user in operation 5502.

After the selection of the information related to the image forming apparatus is received in operation 5502, it is determined whether the corresponding image forming apparatus and the electronic device 200 are currently connected to a same wireless network and able to perform an image forming job in operation S503.

When it is determined that the image forming apparatus and the electronic device 200 are not connected, it is determined whether there is available network information that may be used by the electronic device 200 for connection with the selected image forming apparatus in operation S504. For example, it may be determined whether such network information is already stored in a memory 230 of the electronic device 200. The pre-stored wireless network setup information may include information that has been stored in association with identification information (e.g., an identifier of the image forming apparatus, an IP address, etc.) of the image forming apparatus when the corresponding image forming apparatus and the electronic device 200 were previously connected, and may include wireless network setup information used in the previous connection between the electronic device 200 and the image forming apparatus. That is, the wireless network setup information (e.g., information for router connection, information for device-to-device connection, etc.) that was used when the electronic device 200 and the image forming apparatus were previously connected to each other through the same wireless network to perform the image forming job may be stored in the electronic device 200.

When it is determined that there is no pre-stored network setup information, the electronic device 200 may request the user to, for example, change the current wireless network connection setting of the electronic device 200 to be the same as that of a wireless network to which a desired image forming apparatus is currently connected in operation 5505. For example, the electronic device 200 may display a notification to the user through the display for guiding the user to change the wireless network connection setting of the electronic device 200 in a setup menu of the electronic device 20. Alternatively, instead of requesting an explicit input from the user, the electronic device 200 may access a separate database that may provide corresponding information and obtain the wireless network setup information required for the current connection setup.

In contrast, when the electronic device 200 determines that there is pre-stored network setup information in association with the image forming apparatus to be used in operation 5504, the pre-stored wireless network setup information is obtained in operation S506. Based on the wireless network setup information so obtained, a wireless network setup process for the electronic device 200 can be controlled in operation 5508. For example, a current wireless network connection setting of the electronic device 200 may be changed according to the pre-stored wireless network setup information, and, thus, the electronic device 200 may access the same wireless network as the one to which the image forming apparatus is connected, and be connected to the image forming apparatus. As a result, once there is a history of successful connection between the image forming apparatus and the electronic device 200, the wireless network connection setup for connecting the image forming apparatus with the electronic device 200 may be automatically performed thereafter without user intervention, thereby improving user experience.

In an example, prior to changing the wireless network setting of the electronic device 200 according to the obtained wireless network setup information in operation S508, the electronic device 200 may also store the network setup information on the wireless network to which the electronic device 200 is currently connected in operation S507. The current wireless network setup information may be stored, for example, in the memory 230 or other suitable storage. The current wireless network setup information stored in this way may be later used when the user, after completing the image forming job, wants to reconnect to the previous wireless network that was used prior to the image forming job, either automatically or on the basis of a command from the user.

When it is determined that the image forming apparatus and the electronic device 200 are connected to the same wireless network in operation S503, the electronic device 200 may associate the wireless network setup information used for the current connection with the identification information of that image forming apparatus, and store same in the memory 230 for later use in operation S509. For instance, when the wireless network setup information used for the current connection is information that was initially input by the user, e.g., information received in response to the notification for explicitly guiding the user to change the network setting of the electronic device 200, the electronic device 200 may store the corresponding wireless network setup information in the memory 230 for later use. Even when there is pre-stored wireless network setup information associated with a connection between an image forming apparatus and the electronic device 200, however, the pre-stored wireless network setup information may be updated and stored if that image forming apparatus and the electronic device 200 are currently connected to each other using a network setting that is different from a previously used setting.

When the electronic device 200 is connected to the same wireless network as the one to which the image forming apparatus is connected, the image forming apparatus may be controlled through the electronic device 200, for example, through the application installed in the electronic device 200. Accordingly, the user may perform a predetermined job on the image forming apparatus in operation 5510.

Alternatively, or additionally, after the desired job is finished by the image forming apparatus, the electronic device 200 may determine whether to return the electronic device 200 to the previous network connection that had been used before the image forming apparatus was used in operation S511. As an example, as illustrated in FIG. 4, the processor 210 of the electronic device 200 may operate to display the user interface 400 on the display 220, through which the user may choose whether to change the network setting of the electronic device 200 according to the previous network setup information after having the job completed by the image forming apparatus. The user interface 400 may display an interface that receives from the user an input on whether to return the network setting of the electronic device 200 to the previous network setting that has been used prior to the connection with the image forming apparatus, together with a network identifier corresponding to the wireless network setup information to be restored.

When the electronic device 200 receives an input indicating that the user selects to restore the previous network, the electronic device 200 may change its wireless network setting using the wireless network connection information that has been stored prior to the connection with the image forming apparatus, as described above, and be reconnected to the wireless network to which it had been connected prior to the connection with the image forming apparatus in operation S512.

In contrast, the electronic device 200 may automatically return to the previous network setting without inquiring upon the user, or may maintain the wireless network setting used for the current connection with the image forming apparatus, which may be chosen by the user through a setup menu of the application installed in the electronic device 200.

Thereafter, the execution of the application for using the image forming apparatus installed in the electronic device 200 terminates in operation S513.

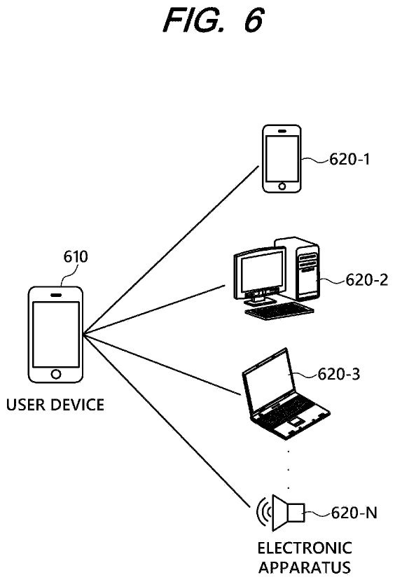

FIG. 6 is a schematic diagram of a system comprising electronic devices and a user device according to an example.

Referring to FIG. 6, an example method of changing a wireless network setting for connection between a user device 610 and electronic devices 620-1, 620-2, 620-3, . . . , 620-N is provided. As can be appreciated, the diagram explained in FIG. 6 is merely an example and the user device 610 or the electronic devices 620-1 to 620-N should not be limited to the form of those of the example illustrated in FIG. 6.

The user device 610 may be, for example, a mobile phone terminal of a user. The user device 610 may be connected to other electronic devices, for example, one or more electronic devices of the electronic devices 620-1 to 620-N and control the corresponding electronic devices. The one or more electronic devices may include, but are not limited to, for example, another mobile phone terminal, a personal computer (PCs), a laptop computer, a wireless speaker, etc.

Control of the electronic devices 620-1 to 620-N through the user device 610 may be performed by, e.g., an application installed in the user device 610. However, examples are not limited thereto. When the user device 610 is connected to the electronic devices 620-1 to 620-N to control the electronic devices 620-1 to 620-N, the user device 610 and the electronic devices 620-1 to 620-N need to be connected to a same wireless network. Therefore, if the user device 610 is connected to a different network from the electronic devices 620-1 to 620-N, it may be necessary to change a wireless network setting of the user device 610, so that the electronic devices 620-1 to 620-N can be controlled through the application installed in the user device 610. In the above situation, the application of the user device 610 may operate in the same manner as the application installed in the electronic device 200 described above with reference to the examples of FIGS. 1 to 5 and change a wireless network setting of the user device 610. For example, in the method described with reference to FIG. 5, it may be considered that the image forming apparatuses correspond to the electronic devices 620-1 to 620-N and the electronic device corresponds to the user device 610. Therefore, the method of changing the wireless network setting of the user device 610 performed by the application of the user device 610 may be the same as that described above in reference to the example of FIG. 5, and an additional description thereof will be omitted

Each of the example operations included in the above-described method may be implemented through a computer program to perform the operations corresponding thereto, and the computer program may be stored in a non-transitory computer-readable recording medium and executed by a processor.

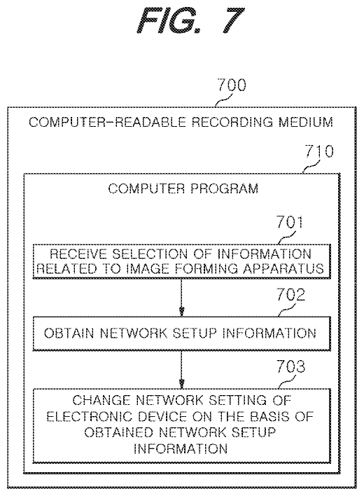

FIG. 7 illustrates a computer program stored on a computer-readable recording medium according to an example.

Referring to FIG. 7, a computer program 710 may be stored on a computer-readable recording medium 700.

The computer program 710 may include instructions 701 for receiving a selection of information related to an image forming apparatus.

Further, the computer program 710 may include instructions 702 for obtaining wireless network setup information used for connecting an image forming apparatus corresponding to the information related to the selected image forming apparatus with an electronic device.

Further, the computer program 710 may include instructions 703 for changing a wireless network setting of the electronic device on the basis of the obtained wireless network setup information.

In various examples, the operations described above with reference to FIG. 5, and the instructions 701, 702, and 703 as described above, may be performed by the electronic device 200 described above or an application installed in the electronic device 200 by the execution of the computer program stored in the computer-readable recording medium 700. Therefore, the description presented above with regard to the example operations of the electronic device 200 or the network setup method of the electronic device is applied to these operations as well.

The computer readable storage medium 700 may be a non-transitory readable medium. The term “non-transitory readable medium” as used herein refers to a medium that is capable of semi-permanently storing data and is readable by an apparatus, rather than a medium, e.g., a register, a cache, a volatile memory device, etc., that temporarily stores data. For example, the foregoing program instructions may be stored and provided in a CD, a DVD, a hard disk, a Blu-ray disc, a USB, a memory card, a ROM device, or any of other type of non-transitory readable media.

In an example, the examples disclosed herein may be incorporated into a computer program product. The computer program product may be available as a product for trading between a seller and a buyer. The computer program product may be distributed in the form of a machine-readable storage medium, e.g., compact disc read only memory (CD-ROM), or distributed online through an application store, e.g., PlayStoreTM. For online distribution, at least a portion of the computer program product may be temporarily stored, or temporarily created, in a storage medium such as a server of the manufacturer, a server of the application store, or a storage medium such as a memory of a relay server.

The foregoing description has been presented to illustrate and describe various examples. It should be appreciated by those skilled in the art that modifications and variations are possible in light of the above teaching. In various examples, suitable results may be achieved if the above-described techniques are performed in a different order, and/or if some of the components of the above-described systems, architectures, devices, circuits, and the like are coupled or combined in a different manner, or substituted for or replaced by other components or equivalents thereof.

Therefore, the scope of the disclosure is not to be limited to the precise form disclosed, but rather defined by the following claims and equivalents thereof.

What is claimed is:

1. A wireless network setup method of an electronic device, the method comprising:
executing an application for use of an image forming apparatus, wherein the image forming apparatus is connected to a network different from one to which the electronic device is connected;
displaying information related to a plurality of image forming apparatuses shared in the application;
receiving a selection of information related to the image forming apparatus through the application;
obtaining the information related to the image forming apparatus; and
changing a wireless network setting of the electronic device for connection of the electronic device with the image forming apparatus based on wireless network setup information corresponding to the obtained information related to the image forming device.

2. The method of claim
wherein the information related to the image forming apparatus includes identification information of the image forming apparatus, and
wherein the wireless network setup information is associated with the identification information of the image forming apparatus.

3. The method of claim 2, further comprising storing the wireless network setup information in a memory of the electronic device prior to the selection of the information related to the image forming apparatus,
wherein the wireless network setup information includes information that was used when the electronic device was connected to the image forming apparatus prior to the selection.

4. The method of claim 2, further comprising storing current wireless network setup information of the electronic device prior to the changing of the wireless network setting of the electronic device.

5. The method of claim 4, further comprising displaying, on the application, a user interface for receiving an input on whether to change the wireless network setting of the electronic device after completion of a job to be performed by the image forming apparatus.

6. The method of claim 5, wherein the displaying of the user interface comprises:
displaying an interface for receiving a selection to return the wireless network setting of the electronic device to a previous wireless network setting that was used prior to the connection with the image forming apparatus; and
displaying wireless network related information corresponding to the current wireless network setup information.

7. The method of claim 1, wherein the changing of the wireless network setting of the electronic device comprises connecting the electronic device to the wireless network to which the image forming apparatus is connected so that the electronic device and the image forming apparatus are connected to the same wireless network.

8. A wireless network setup method of a user device, the method comprising:
executing an application for use of an electronic apparatus, wherein the electronic apparatus is connected to a network different from one to which the user device is connected;
displaying information related to a plurality of electronic apparatuses stored in the application;
receiving a selection of information related to the electronic apparatus through the application;
obtaining the information related to the electronic apparatus; and
changing a wireless network setting of the user device for connection of the user device with the electronic apparatus based on wireless network setup information corresponding to the obtained information related to the electronic apparatus.

9. The method of claim 8,
wherein the information related to the electronic apparatus includes identification information of the electronic apparatus, and
wherein the wireless network setup information is associated with the identification information of the electronic apparatus.

10. The method of claim 8, further comprising storing the wireless network setup information in a memory of the user device prior to the selection of the information related to the electronic apparatus,
wherein the wireless network setup information includes information that was used when the user device was connected to the electronic apparatus prior to the selection.

11. The method of claim 8, further comprising storing current wireless network setup information of the user device prior to the changing of the wireless network setting of the user device.

12. The method of claim 11, further comprising displaying, on the application, a user interface for receiving an input on whether to change the wireless network setting of the user device after completion of a job to be performed by the electronic apparatus.

13. The method of claim 12, wherein the displaying of the user interface comprises:
displaying an interface for receiving a selection to return the wireless network setting of the user device to a previous wireless network setting that was used prior to the connection with the electronic apparatus: and
displaying wireless network related information corresponding to the current wireless network setup information.

14. The method of claim 8, wherein the changing of the wireless network setting of the user device comprises connecting the user device to the wireless network to which the electronic apparatus is connected so that the user device and the electronic apparatus are connected to the same wireless network.

15. A computer-readable recording medium having a computer program stored therein for a wireless network setup method of an electronic device, the computer-readable recording medium including:
instructions to execute an application for use of an image forming apparatus, wherein the image forming apparatus is connected to a network different from one to which an electronic device is connected;
instructions to display information related to one or more image forming apparatuses stored in the application;
instructions to receive a selection of information related to the image forming apparatus through the application;
instructions to obtain the information related to the image forming apparatus; and
instructions to change a wireless network setting of the electronic device for connection of the electronic device with the image forming apparatus based on wireless network setup information corresponding to the obtained information related to the image forming device.
